(19) United States
(12) Patent Application Publication
(10) Pub. No.: US 2009/0224986 A1
(43) Pub. Date: Sep. 10, 2009

(54) RADIO APPARATUS AND ANTENNA DEVICE HAVING ELEMENT FORMED ON CASING MATERIAL

(75) Inventors: Hiroyuki HOTTA, Tokyo (JP); Masao TESHIMA, Tokyo (JP); Hiroshi SHIMASAKI, Tokyo (JP); Akihiro TSUJIMURA, Tokyo (JP); Satoshi MIZUGUCHI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/360,182

(22) Filed: Jan. 27, 2009

(30) Foreign Application Priority Data
Mar. 5, 2008 (JP) 2008-55350

(51) Int. Cl. H01Q 1/24

(52) U.S. Cl. 343/702

(57) ABSTRACT

A radio apparatus including a printed board having an antenna feed circuit, a casing material provided with an antenna element, an antenna feed material, and an electric connection between the antenna feed circuit and the antenna element is provided. The antenna element is formed by a conductive pattern formed on a face of the casing material facing the printed board. The antenna feed material is arranged between the face of the casing material and the printed board. The electric connection connects the antenna feed circuit and the antenna element through the antenna feed material.

### CROSS REFERENCE TO RELATED APPLICATIONS

This application is based upon and claims the benefit of priority from the prior Japanese Patent Application No. 2008-55350 filed on Mar. 5, 2008; the entire contents of which are incorporated herein by reference.

### BACKGROUND OF THE INVENTION

1. Field of the Invention

The present invention relates to a radio apparatus and an antenna device, and in particular to a radio apparatus and an antenna device having an antenna element formed on a casing material of the radio apparatus.

2. Description of the Related Art

It is generally known that a radio apparatus, e.g., a mobile phone has a built-in antenna device contained in a casing material these days instead of an antenna device that may be extended outside of the casing material, e.g., a whip antenna that used to be popular. The radio apparatus may enjoy improved design and operability by employing the built-in antenna. In recent years, however, as the radio apparatus is required to have multiple functions and high performances and to be downsized and slim at the same time, the antenna device faces difficulty in performing as required in a condition such as contained in limited space of the casing material.

In order to deal with the above difficulty, e.g., it has been developed to form a conductive pattern on a casing material of a radio apparatus by using a method of, e.g., plating and to feed the conductive pattern as an antenna. Such an antenna may generally be fed through a feed pin in contact with the conductive pattern, instead of a feed line soldered to the conductive pattern, as it should be taken into account that the casing material often made of plastic has limited heat-resistance.

There is a problem, however, that a relative position between a printed board on which an antenna feed circuit is mounted and the casing material may affect where to put the feed pin and may limit a degree of freedom, as the feed pin has to be put in a fixed direction. In addition, in order to simplify assembly work in a manufacturing process, it is preferable to reduce the number and the size of the feed pins as much as possible. It is not known how to solve the above problem or how to meet the above manufacturing process requirement.

An antenna built-in module formed by an antenna feed circuit and an antenna combined with each other is disclosed in Japanese Patent Publication of Unexamined Applications (Kokai), No. 2005-5866.

According to JP 2005-5866, the antenna built-in module has a circuit board on which a radio circuit is provided, a cover made of sheet metal arranged in such a way as to almost entirely cover the circuit board, and an exclusive shield case made of sheet metal arranged in such a way as to cover a specific area on the circuit board.

The cover is not limited to be made of sheet metal and may be shaped as a lid of a box made of plastic and provided with a conductive layer on a surface of the box lid. In that case, a portion of the conductive layer formed on an upper plate of the box lid may work as a radiation conductor, and a portion of the conductive layer formed on a side wall of the box lid may work as a feed conductor and a grounded conductor.

The antenna built-in module of JP 2005-5866 is configured in such a way that the conductive layer formed on the side wall of the box lid may connect the radio circuit provided on the circuit board to the conductive layer formed on the upper plate of the box lid made of plastic.

As it is generally known that a printed board of a radio apparatus, e.g., a mobile phone, on which an antenna feed circuit is provided and a casing material of the radio apparatus may hardly be formed as one piece, the antenna built-in module of JP 2005-5866 may not be applied to such a radio apparatus.

### SUMMARY OF THE INVENTION

Accordingly, an object of the present invention is to feed an antenna element formed by a conductive pattern formed, e.g., plated, on a casing material by using a small number of short feed pins located with a high degree of freedom.

To achieve the above object, according to one aspect of the present invention, a radio apparatus including a printed board having an antenna feed circuit, a casing material provided with an antenna element, an antenna feed material, and an electric connection between the antenna feed circuit and the antenna element is provided. The antenna element is formed by a conductive pattern formed on a face of the casing material facing the printed board. The antenna feed material is arranged between the face of the casing material and the printed board. The electric connection connects the antenna feed circuit and the antenna element through the antenna feed material.

### BRIEF DESCRIPTION OF THE DRAWINGS

FIG. 1 is a perspective view of a radio apparatus of a first embodiment of the present invention.

FIG. 2 is a cross sectional view of a portion of a section of the radio apparatus of the first embodiment.

FIG. 3 is a cross sectional view of a portion of a section of a modification of the radio apparatus of the first embodiment.

FIG. 4 is a diagram showing an antenna feed connection of a radio apparatus of a second embodiment of the present invention.

FIG. 5 is a diagram showing another antenna feed connection of the radio apparatus of the second embodiment of the present invention.

FIG. 6 is a diagram showing a modification of the antenna feed connection of the radio apparatus of the second embodiment shown in FIG. 4.

FIG. 7 is a diagram showing a modification of the antenna feed connection of the radio apparatus of the second embodiment shown in FIG. 5.

FIG. 8 is a diagram showing another modification of the antenna configuration and the antenna feed connection of the radio apparatus of the second embodiment, including an additional conductive pattern formed on the antenna feed material.

FIG. 9 is a diagram showing yet another modification of the antenna configuration and the antenna feed connection of the radio apparatus of the second embodiment, including the additional conductive pattern formed on the antenna feed material.

FIG. 10 is a diagram showing an antenna feed connection of a radio apparatus of a third embodiment of the present invention.

FIG. 11 is a diagram showing a modification of the antenna feed connection of the radio apparatus of the third embodiment.

FIG. 12 is a diagram showing another modification of the antenna feed connection of the radio apparatus of the third embodiment.

FIG. 13 is a cross sectional view of a portion of a section of a radio apparatus of a fourth embodiment of the present invention.

FIG. 14 is a diagram showing an antenna feed connection of the radio apparatus of the fourth embodiment.

FIG. 15 is a diagram showing an antenna configuration and an antenna feed connection of a radio apparatus of a fifth embodiment of the present invention.

### DETAILED DESCRIPTION OF THE INVENTION

Hereinafter, embodiments of the present invention will be described in detail. In following descriptions, terms such as upper, lower, left, right, horizontal or vertical used while referring to a drawing shall be interpreted on a page of the drawing unless otherwise noted. A same reference numeral given in no less than two drawings shall represent a same member or a same portion.

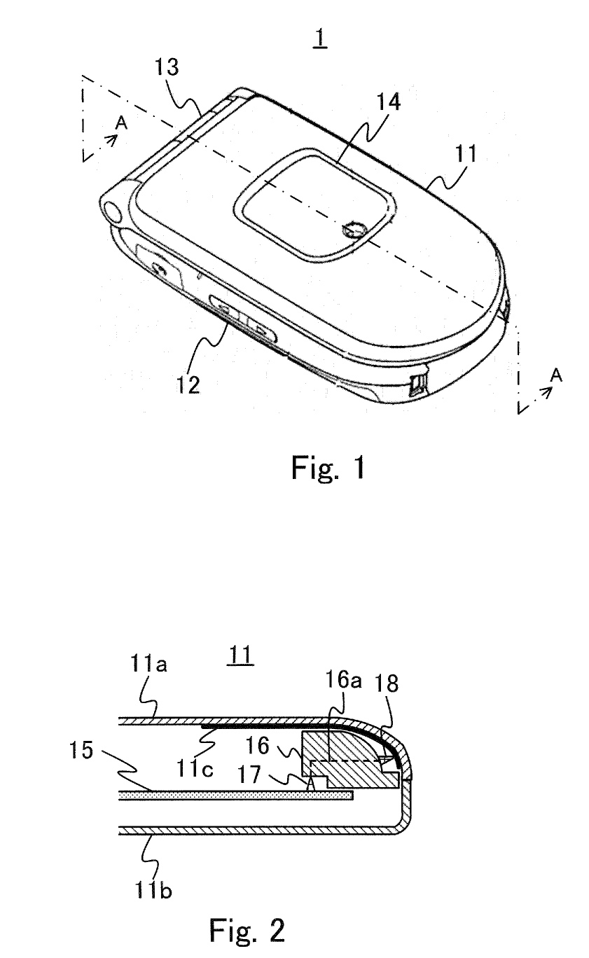

A first embodiment of the present invention will be described with reference to FIGS. 1-3. FIG. 1 is a perspective view of a radio apparatus 1 of the first embodiment. The radio apparatus 1 has a first section 11, a second section 12 and a connection 13 movably connecting the first section 11 and the second section 12 in such a way as to open or close the two sections to each other. FIG. 1 shows a state that the first section 11 and the second section 12 are closed to each other. The first section 11 has an auxiliary display 14 made of, e.g., a liquid crystal display device.

FIG. 2 is a cross sectional view of the first section 11 along a line with arrows A-A shown in FIG. 1 partially showing an end portion of the first section 11 that is farther from the connection 13. The first section 11 is formed by an upper piece 11a and a lower piece 11b both made of dielectric material and mechanically joined in a vertical direction.

The first section 11 contains a radio circuit that is not shown and a printed board 15 in which a feed line formed by a conductive pattern that is not shown is provided. The radio circuit and the conductive pattern are called an antenna feed circuit together.

The upper piece 11a has an inner face facing the printed board 15, and a conductive pattern 11c is formed on the inner face of the upper piece 11a. More specifically, the inner face of the upper piece 11a is provided with an adhesive layer (not shown) made of dielectric material being different from the material of the upper piece 11a. The conductive pattern 11c may be plated through the adhesive layer.

Owing to existence of the adhesive layer, the upper piece 11a may be provided with the conductive pattern 11c no matter what kind of material the upper piece 11a is made of. Thus, the material of the upper piece 11a may be selected from reinforced dielectric material that is necessary for the radio apparatus 1 to be stiff and thinner.

The upper piece 11a may have a conductive pattern that is not shown and formed on an outer face of the upper piece 11a. The conductive pattern on the outer face may be connected to the conductive pattern 11c by turning around an edge of the upper piece 11a or though a via hole that is not shown and penetrates between the inner and outer faces of the upper piece 11a.

The upper section 11 contains an antenna feed material 16 arranged between the inner face of the upper piece 11a and the printed board 15. The antenna feed material 16 is made of nonconductive material, e.g., plastic, and has a feed conductor 16a shown by a dashed line. The feed conductor 16a may be formed, e.g., by being plated on a surface of the antenna feed material 16, or as a via hole that penetrates inside the antenna feed material 16.

An end of the feed conductor 16a that is nearer to the printed board 15 is connected to the antenna feed circuit (more specifically, the conductive pattern that is not shown) of the printed board 15 through a first feed pin 17. Another end of the feed conductor 16a that is nearer to the upper piece 11a is connected to the conductive pattern 11c through a second feed pin 18.

The first feed pin 17 and the second feed pin 18 are a means of electrical connection, generally called a spring pin, having a plunger through a spring arranged in a metallic pipe. A tip of the plunger may be pressed against a conductive face of the other party of connection so as to obtain electrical conduction.

The first feed pin 17 may be provided on the printed board 15 and the tip of the plunger may be pressed against the end of the feed conductor 16a that is nearer to the printed board 15. The first feed pin 17 may be provided on the antenna feed material 16 and connected to the end of the feed conductor 16a that is nearer to the printed board 15, and the tip of the plunger may be pressed against the antenna feed circuit of the printed board 15.

The second feed pin 18 may be provided on the antenna feed material 16 and connected to the end of the feed conductor 16a that is nearer to the upper piece 11a, and the tip of the plunger may be pressed against the conductive pattern 11c. The second feed pin 18 may be provided on the upper piece 11a and the tip of the plunger may be pressed against the end of the feed conductor 16a that is nearer to the upper piece 11a.

According to the above configuration, the conductive pattern 11c is connected to the antenna feed circuit of the printed board 15, and may be fed as, e.g., a monopole antenna. As shown in FIG. 2, a portion of the antenna feed material 16 that is connected to the antenna feed circuit of the printed board 15 is separated from the printed board 15. The separation may be made so small that the first feed pin 17 may be made short enough to improve assembly work efficiency.

The antenna feed material 16 may be formed in such a way that a short feed pin may be used as the second feed pin 18 after the antenna feed material 16 is arranged in place. As shown in FIG. 2, a portion of the antenna feed material 16 that is connected to the conductive pattern 11c through the second feed pin 18 may be shaped in accordance with a shape of the upper piece 11a, so that where to arrange the antenna feed material 16 may be selected more freely although the second feed pin 18 has to be put in a fixed direction.

As being arranged in such a way as to fill space around the end portion of the first section 11 that is farther from the connection 13, the antenna feed material 16 may mechanically reinforce the first section 11.

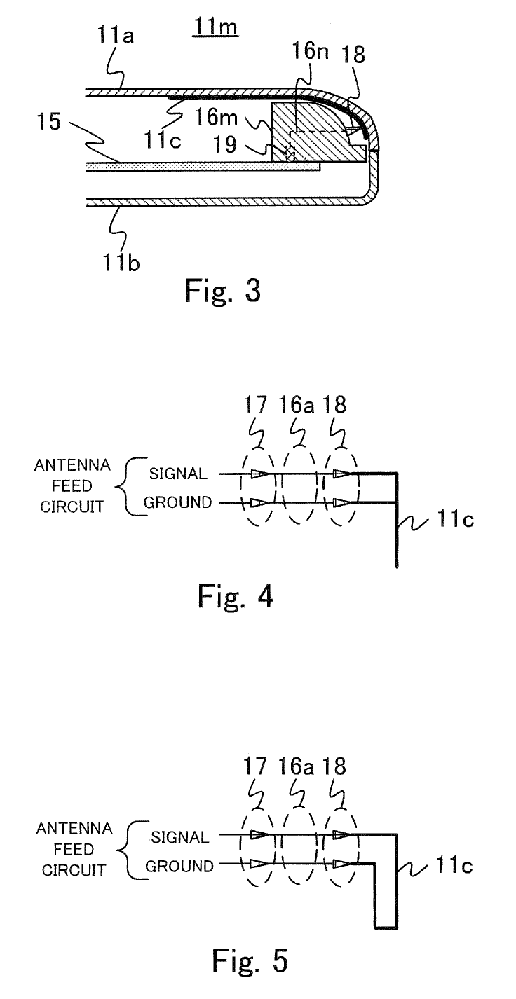

A modification of the first embodiment will be described with reference to FIG. 3. FIG. 3 is a cross sectional view of a portion of a first section 11m, i.e., a modification of the first section 11 described above and shown in FIG. 2. Each of portions shown in FIG. 3 which is a same as the corresponding one shown in FIG. 2 is given the same reference numeral (11a, 11b, 15 and 18) and its explanation is omitted.

An antenna feed material 16m is put on a face of the printed board 15 facing the inner face of the upper piece 11a of the first section 11. The antenna feed material 16m is made of nonconduct material, e.g., plastic, and has a feed conductor 16n shown by a dashed line. The feed conductor 16n may be formed, e.g., by being plated on a surface of the antenna feed material 16m, or as a via hole that penetrates inside the antenna feed material 16m.

An end of the feed conductor 16n that is nearer to the printed board 15 is connected to the antenna feed circuit of the printed board 15 through a connector 19. The connector 19 is a pair of connectors put on the antenna feed material 16m and the printed board 16n and joined to each other.

An end of the feed conductor 16n that is nearer to the upper piece 11a is connected to the conductive pattern 11c through the second feed pin 18.

According to the above modified configuration, the conductive pattern 11c is connected to the antenna feed circuit of the printed board 15, and may be fed as, e.g., a monopole antenna. The first section 11m may lack the first feed pin 17 included in the first section 11 shown in FIG. 2, and thus may further improve the assembly work efficiency.

According to the first embodiment of the present invention described above, a radio apparatus that may use a conductive pattern formed on a casing material as an antenna element may feed the antenna element through a small number of short feed pins located with a high degree of freedom.

A second embodiment of the present invention will be described with reference to FIGS. 4-9. A radio apparatus of the second embodiment is a same as the radio apparatus 1 given the same reference numeral of the first embodiment for convenience of explanation, having a conductive pattern formed on a casing material configured to be fed by an antenna feed circuit provided on a printed board through an antenna feed material and feed pins, as described with respect to the first embodiment. Each of portions of the radio apparatus 1 of the second embodiment is given the same reference numeral as shown in FIG. 2.

The conductive pattern 11c of the second embodiment, however, may be used as an antenna such as an inverted F antenna that may be fed and grounded at one and another portions of the antenna, respectively. FIG. 4 is a diagram showing an antenna feed connection of the radio apparatus 1 of the second embodiment.

As shown in FIG. 4, the first feed pin 17 is formed by a signal side and a ground side paired with each other, and so are the feed conductor 16a and the second feed pin 18 (each of the pairs is shown as surrounded by a dashed ellipse in FIG. 4). The conductive pattern 11c may be used as an inverted F antenna. A portion of the conductive pattern 11c is connected to a signal side of the antenna feed circuit through the signal sides of the second feed pin 18, the feed conductor 16a and the first feed pin 17. Another portion of the conductive pattern 11c is connected to a ground side of the antenna feed circuit through the ground sides of the second feed pin 18, the feed conductor 16a and the first feed pin 17.

FIG. 5 is a diagram showing another antenna feed connection of the radio apparatus 1 of the second embodiment. In FIG. 5, as similarly shown in FIG. 4, the first feed pin 17 is formed by a signal side and a ground side paired with each other, and so are the feed conductor 16a and the second feed pin 18 (each of the pairs is shown as surrounded by a dashed ellipse in FIG. 5). The conductive pattern 11c may be used as a folded monopole antenna having a grounded end. A portion of the conductive pattern 11c is connected to a signal side of the antenna feed circuit through the signal sides of the second feed pin 18, the feed conductor 16a and the first feed pin 17. Another portion of the conductive pattern 11c is connected to a ground side of the antenna feed circuit through the ground sides of the second feed pin 18, the feed conductor 16a and the first feed pin 17.

As described above, the conductive pattern 11c may be used as an antenna of a type that may be fed and grounded at one and another portions of the antenna, respectively, by using the first feed pin 17, the feed conductor 16a and the second feed pin 18 formed by the pairs of the signal side and the ground side. The first feed pin 17 may be formed by a pair of short feed pins that are similar to the short feed pins of the first embodiment, and so may be the second feed pin 18.

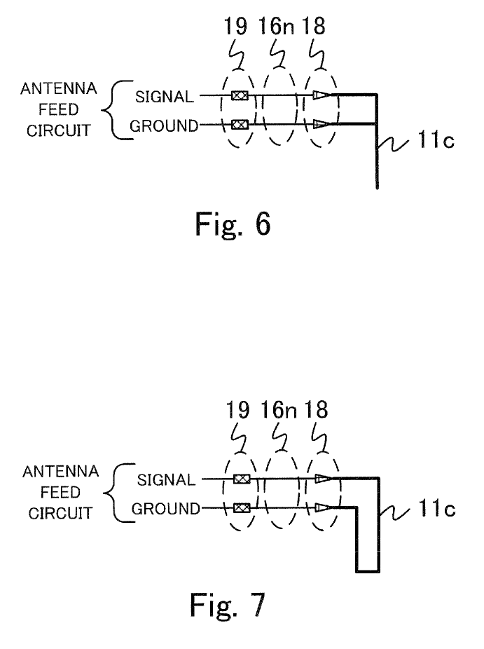

A modification of the second embodiment will be described with reference to FIGS. 6-7. FIG. 6 is a diagram showing a modification of the antenna feed connection of the second embodiment shown in FIG. 4 that the first feed pin 17 is replaced by the connector 19 (i.e., a pair of connectors joined to each other as described with respect to the modification of the first embodiment) as similarly shown in FIG. 3. Each of portions of the modification shown in FIG. 6 is given a same reference numeral as shown in FIG. 3 for convenience of explanation.

As shown in FIG. 6, the connector 19 is formed by a signal side and a ground side paired with each other, and so are the feed conductor 16n and the second feed pin 18 (each of the pairs is shown as surrounded by a dashed ellipse in FIG. 6). The conductive pattern 11c may be used as an inverted F antenna. A portion of the conductive pattern 11c is connected to a signal side of the antenna feed circuit through the signal sides of the second feed pin 18, the feed conductor 16n and the connector 19. Another portion of the conductive pattern 11c is connected to a ground side of the antenna feed circuit through the ground sides of the second feed pin 18, the feed conductor 16n and the connector 19

FIG. 7 is a diagram showing a modification of the different antenna feed connection of the second embodiment shown in FIG. 5 that the first feed pin 17 is replaced by the connector 19 similarly as shown in FIG. 3. In FIG. 7, as similarly shown in FIG. 6, the connector 19 is formed by a signal side and a ground side paired with each other, and so are the feed conductor 16n and the second feed pin 18 (each of the pairs is shown as surrounded by a dashed ellipse in FIG. 7). The conductive pattern 11c may be used as a folded monopole antenna having a grounded end. A portion of the conductive pattern 11c is connected to a signal side of the antenna feed circuit through the signal sides of the second feed pin 18, the feed conductor 16n and the connector 19. Another portion of the conductive pattern 11c is connected to a ground side of the antenna feed circuit through the ground sides of the second feed pin 18, the feed conductor 16n and the connector 19.

As described above, the conductive pattern 11c may be used as an antenna of a type that may be fed and grounded at one and another portions of the antenna, respectively, by using the connector 19, the feed conductor 16n and the second feed pin 18 formed by the pairs of the signal side and the ground side. The antenna feed connection shown in FIG. 7 may lack the first feed pin 17 included in the antenna feed connection of the second embodiment shown in FIG. 4 or FIG. 5, and thus may further improve the assembly work efficiency.

The antenna that may be fed and grounded at one and another portions of the antenna is not limited to the above examples of the inverted F antenna or the folded monopole antenna having a grounded end.

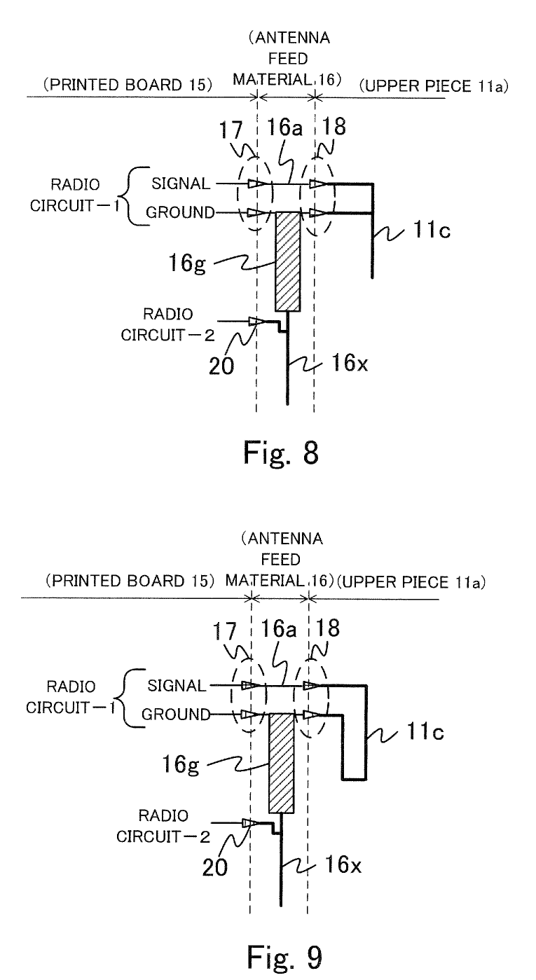

Another modification of the second embodiment will be described with reference to FIGS. 8-9. This modification has an additional conductive pattern formed on a surface of or inside the antenna feed material 16 and connected to a separate feed system. The above additional conductive pattern may be used for an application other than an application of the antenna formed by the conductive pattern formed on the casing material. That is, e.g., the former is applied to a mobile phone use and the latter is applied to a wireless local area network (WLAN) use.

FIG. 8 is a diagram showing an antenna configuration and an antenna feed connection of the modification described just above. Location of each portion of the modification shown in FIG. 8 may be divided into three areas, i.e., on the printed board 15, on the antenna feed material 16 and on the upper piece 11a as divided by vertical dashed lines. Additional conductive patterns, i.e., a ground pattern 16g and an antenna element pattern 16x, are formed on the antenna feed material 16.

As shown on a left side of FIG. 8, the printed circuit 15 includes two kinds of radio circuits. One is a “radio circuit-1” connected to the paired first feed pin 17. The signal side and the ground side of the first feed pin 17 are connected to a feed portion and a ground portion of the conductive pattern 11c forming an inverted F antenna through the feed conductor 16a and the ground conductor 16g, respectively. Another one is a “radio circuit-2” connected to the antenna element pattern 16x through another feed pin 20 provided in the printed board 15.

As what is shown in FIG. 9 is a same as shown in FIG. 8 except that the conductive pattern 11c forms a folded monopole antenna, its explanation is omitted.

According to the modifications shown in FIGS. 8-9, an antenna element for an additional system may be formed on the antenna feed material 16 and the two systems may have the ground pattern in common so that an additional effect may be obtained that the additional system may lack a feed pin of the ground side.

According to the second embodiment of the present invention described above, a radio apparatus that may use a conductive pattern formed on a casing material as an antenna element and partially grounded may feed and ground the antenna element through a small number of paired short feed pins located with a high degree of freedom.

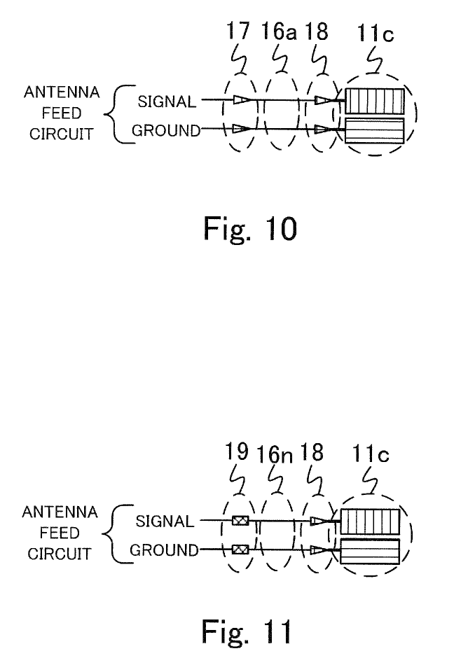

A third embodiment of the present invention will be described with reference to FIGS. 10-13. A radio apparatus of the third embodiment is a same as the radio apparatus 1 given the same reference numeral of the first embodiment for convenience of explanation, having a conductive pattern formed on a casing material configured to be fed by an antenna feed circuit provided on a printed board through an antenna feed material and feed pins, as described with respect to the first embodiment. Each of portions of the radio apparatus 1 of the third embodiment is given the same reference numeral as shown in FIG. 2

The conductive pattern 11c of the third embodiment, however, is formed by a pair of conductive patterns of a signal side and a ground side. FIG. 10 is a diagram showing an antenna feed connection of the radio apparatus 1 of the third embodiment.

As shown in FIG. 10, the first feed pin 17 is formed by the signal side and the ground side paired with each other, and so are the feed conductor 16a and the second feed pin 18 (each of the pairs is shown as surrounded by a dashed ellipse in FIG. 10). The conductive pattern 11c is formed as a pair of conductive patterns of the signal side and of the ground side. The signal side of the conductive pattern 11c is connected to a signal side of the antenna feed circuit through the signal sides of the second feed pin 18, the feed conductor 16a and the first feed pin 17. The ground side of the conductive pattern 11c is connected to a ground side of the antenna feed circuit through the ground sides of the second feed pin 18, the feed conductor 16a and the first feed pin 17.

As described above, each of the first feed pin 17, the feed conductor 16a, the second feed pin 18 and the conductive pattern 11c may be formed as a pair of the signal side and the ground side so as to form an antenna having a ground region on a face of the upper piece 11a. Although using an unbalanced current excited and distributed on the ground region as a main radiation source, an antenna may not have a sufficient size of a ground region on the printed board 15. Even in such a case, the ground region may be enlarged on the upper piece 11a so that the antenna gain may be improved. The antenna may be fed through paired short feed pins as similarly described with respect to the second embodiment.

A modification of the third embodiment will be described with reference to FIG. 11, showing a modification of the antenna feed connection of the third embodiment shown in FIG. 10 that the first feed pin 17 is replaced by the connector 19 (a pair of connectors joined to each other as described with respect to the modification of the first embodiment) as similarly shown in FIG. 3. Each of portions of the modification shown in FIG. 11 is given a same reference numeral as shown in FIG. 3 for convenience of explanation.

As shown in FIG. 11, the connector 19 is formed by a signal side and a ground side paired with each other, and so are the feed conductor 16n, the second feed pin 18 and the conductive pattern 11c (each of the pairs is shown as surrounded by a dashed ellipse in FIG. 11). The signal side of the conductive pattern 11c is connected to a signal side of the antenna feed circuit through the signal sides of the second feed pin 18, the feed conductor 16n and the connector 19. The ground side of the conductive pattern 11c is connected to a ground side of the antenna feed circuit through the ground sides of the second feed pin 18, the feed conductor 16n and the connector 19.

As described above, each of the connector 19, the feed conductor 16n, the second feed pin 18 and the conductive pattern 11c may be formed as a pair of the signal side and the ground side so as to form an antenna having a ground region on the face of the upper piece 11a. The antenna feed connection shown in FIG. 11 may lack the first feed pin 17 included in the antenna feed connection of the third embodiment shown in FIG. 10, and thus may further improve third embodiment shown in FIG. 10, and thus may further improve the assembly work efficiency.

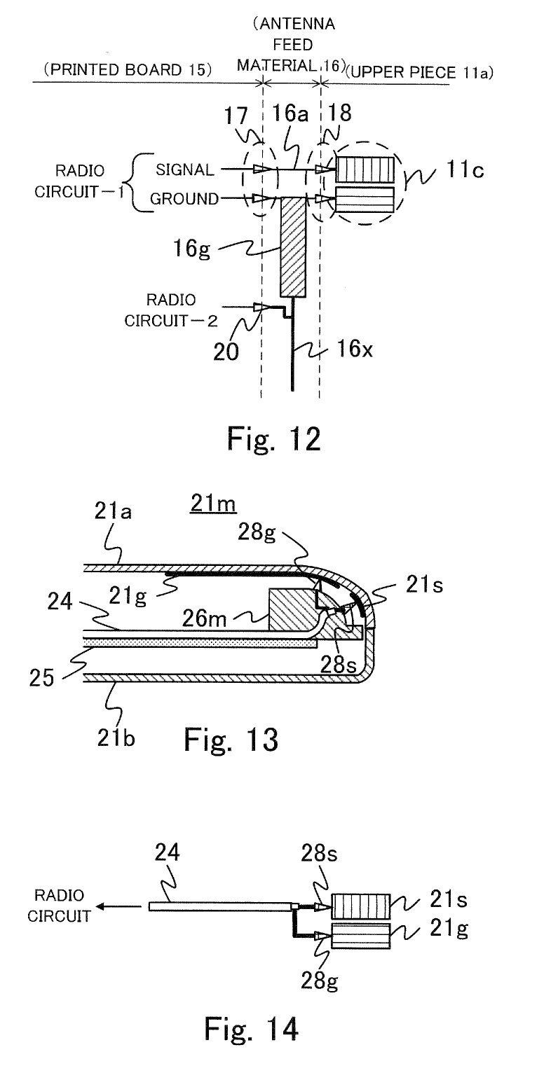

Another modification of the third embodiment will be described with reference to FIG. 12. The modification shown in FIG. 12 is a same as the modification of the second embodiment shown in FIG. 8 except that the conductive pattern 11c is formed by a pair of conductive patterns of the signal side and of the ground side. Thus, an additional effect may be obtained that the additional system may lack a feed pin of the ground side, as similarly described with reference to FIG. 8.

According to the third embodiment of the present invention described above, an additional effect may be obtained that an antenna that may not have a sufficient size of a ground region in a printed board inside a casing material may certainly have a ground region on a face of the casing material.

A fourth embodiment of the present invention will be described with reference to FIGS. 13-14. A radio apparatus of the fourth embodiment has a first section 21m, a second section (not shown) and a connection (not shown) movably connecting the first section 21m and the second section, in such a way as to open or close the two sections to each other, similarly as the radio apparatus 1 shown in FIG. 1. FIG. 13 is a partial cross sectional view of the first section 21m as similarly shown in FIG. 1.

The first section 21m is formed by an upper piece 21a and a lower piece 21b both made of dielectric material and mechanically joined in a vertical direction. The first section 21m contains a printed board 25 on which a radio circuit is provided but is not shown. The radio circuit and a feed line 24 that will be mentioned later are called an antenna feed circuit together.

The upper piece 21a has an inner face facing the printed board 25, and conductive patterns 21s and 21g are formed on the inner face of the upper piece 21a. The conductive patterns 21s and 21g are formed by using a same method as the conductive pattern 11c is as described with reference to FIG. 2.

An antenna feed material 26m made of nonconductive and heat-resistant material (e.g., liquid crystal polymer) is arranged between the inner face of the upper piece 21a and the printed board 25. The antenna feed material 26m may be provided on the face of the printed board 25 facing the inner face of the upper piece 21a as the antenna feed material 16m is as shown in FIG. 3.

Feed pins 28s and 28g are provided on a face of the antenna feed material 26m facing the inner face of the upper piece 21a. Each of the feed pins 28s and 28g is a same as the second feed pin 18 described with reference to FIG. 2. The feed pin 28s is connected to a signal side of the above radio circuit that is provided on the printed board 25 but is not shown through a signal side of a feed line 24. The feed pin 28g is connected to a ground side of the above radio circuit that is provided on the printed board 25 but is not shown through a ground side of the feed line 24.

As the antenna feed material 26m is made of heat-resistant material, tips of the signal side and the ground side of the feed line 24 may be soldered to the feed pin 28s and the feed pin 28g, respectively. Another end of the feed line 24 may be connected to the above radio circuit that is not shown through a conductive pattern formed in the printed board 25. The feed line 24 may be connected to the feed pins 28s and 28g through a conductive pattern formed on a face, or as a via hole, of the antenna feed material 26m by being soldered to the conductive pattern.

Tips of plungers of the feed pins 28s and 28g are pressed against and thus connected to the conductive patterns 21s and 21g, respectively. The feed pins 28s and 28g may be arranged on the upper piece 21a and connected to the conductive patterns 21s and 21g respectively, and the tips of the plungers may be pressed against the conductive patterns formed on the antenna feed material 26m to which tips of signal and ground sides of the feed line 24 are soldered.

According to the above configuration of the fourth embodiment, the conductive patterns 21s and 21g may be fed by being connected to the signal side and the ground side of the antenna feed circuit of the printed board 25. The conductive patterns 21s and 21g may be coupled to each other as a pair of the signal side and the ground side, and so may be the feed pins 28s and 28g, so as to form an antenna having a ground region on the face of the upper piece 21a as similarly described with respect to the third embodiment. Meanwhile, the number of necessary feed pins may be reduced in comparison with the third embodiment.

According to the above configuration of the fourth embodiment, an antenna that uses an unbalanced current excited and distributed in the ground region as a main radiation source may expand the ground region so as to improve the antenna gain, even if having an insufficient size of the ground region in the printed board 25. The antenna may be fed through the pair of the short feed pins 28s and 28g, as similarly described with respect to the previous embodiments. FIG. 14 is a diagram showing an antenna feed connection of the antenna configured as described above. Reference numerals given to the portions shown in FIG. 14 and connections among the portions are same as described with reference to FIG. 13, and their explanations are omitted.

If the conductive patterns 21s and 21g that are separate to each other are replaced by one consecutive conductive pattern 21c, a portion of the conductive pattern 21c is connected to the signal side of the antenna feed circuit, and another portion of the conductive pattern 21c is grounded. Thus, an antenna of a type fed at one portion and grounded at another portion may be formed, as similarly described with respect to the second embodiment, by including a reduced number of the feed pins in comparison with the second embodiment.

In FIG. 13, the conductive pattern 21g may be connected to the ground side through a conductive tape or a conductive gasket instead of the feed pin 28g, so as to further reduce the number of necessary feed pins.

According to the fourth embodiment of the present invention described above, an antenna feed material made of heat-resistant material may be used so that the number of feed pins required for the configuration of the second or the third embodiment may be reduced.

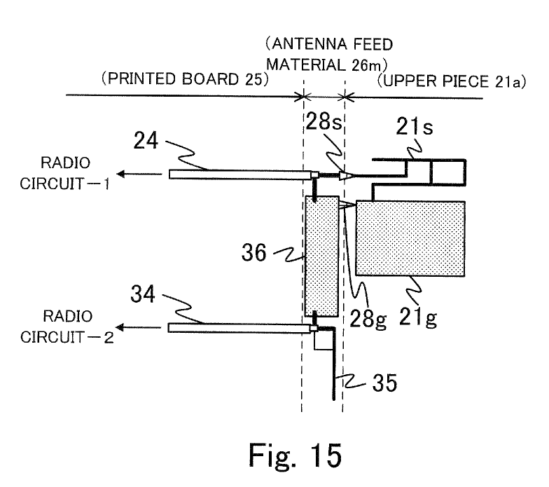

A fifth embodiment of the present invention will be described with reference to FIG. 15. The embodiments described above may be modified in such a way that an additional conductive pattern is formed on or inside the antenna feed material 16 or 26 and connected to a separate feed system, so as to form a radio apparatus of the fifth embodiment.

The above additional conductive pattern may be used for an application other than an application of the antenna formed by the conductive pattern formed on the casing material. That is, e.g., the former is applied to a mobile phone use and the latter is applied to a wireless local area network (WLAN) use. FIG. 15 is an exemplary diagram showing an antenna configuration and an antenna feed connection of the fifth embodiment.

The connection shown in FIG. 15 is based on a modification of the configuration of the fourth embodiment shown in FIG. 13, in such a way that the conductive patterns 21s and 21g are short-circuited by a pattern provided on the surface of the upper piece 21a. Thus, some of reference numerals shown in FIG. 15 are same as shown in FIG. 13. Location of each portion shown in FIG. 8 may be divided into three areas, i.e., on the printed board 25, on the antenna feed material 26m and on the upper piece 21a as divided by vertical dashed lines. The antenna feed material 26m is made of heat-resistant material as described with respect to the fourth embodiment.

As shown on a left side of FIG. 15, the printed circuit 25 includes two kinds of radio circuits. One is a “radio circuit-1” to which the feed line 24, i.e., a same as shown in FIG. 13, is connected. Another one is a “radio circuit-2” to which a feed line 34 of a same kind as the feed line 24 is connected.

As shown in a middle portion of FIG. 15, an additional conductive pattern 35 and a ground pattern 36 are formed on the antenna feed material 26m. Each of tips of ground sides of the feed lines 24 and 34 (e.g., an outer conductor of a coaxial cable) are soldered to the ground pattern 36. A tip of a signal side of the feed line 34 is connected to the additional conductive pattern 35, that is short-circuited nearby with the ground pattern 36 so as to form an inverted F antenna.

A tip of a signal side of the feed line 24 is soldered to the feed pin 28s as described with respect to the fourth embodiment, and is connected to the conductive pattern 21s through the feed pin 28s. The ground pattern 36 is connected to the conductive pattern 21g through the feed pin 28g, so as to form on the ground side a connection being almost equivalent to the connection shown in FIG. 13.

As shown on a right side of FIG. 15, the conductive pattern 21s is formed, e.g., by a combination of a folded monopole antenna element, an open-ended monopole antenna and a short circuit configured to adjust impedance of the open-ended monopole antenna, as disclosed in Japanese Granted Patent Publication (Toroku), No. 3775795. The conductive pattern 21g is an antenna ground region formed on the face of the upper piece 21a as described with respect to the fourth embodiment. As shown in FIG. 15, a tip of the folded monopole antenna included in the conductive pattern 21s is short-circuited to the conductive pattern 21g.

According to the above configuration of the fifth embodiment, only two feed pins are enough to feed the antenna formed on the antenna feed material 26m and the antenna formed on the upper piece 21a separately. Given a three-dimensional shape, the antenna feed material 26m may usually have an advantage over the upper piece 21a of an effective surface area on which antenna element patterns are formed. Thus, it seems appropriate in lots of cases, although not in every case, that antennas of systems using a relatively low frequency and a relatively high frequency are provided on the antenna feed material 26m and on the upper piece 21a, respectively.

As described above with respect to the fifth embodiment, the additional antenna element is added to the antenna feed material 26m on the basis of the configuration shown in FIG. 13 of the fourth embodiment. The additional antenna element is not limited to the above, and may be added to the antenna feed material of any of the embodiments described above.

According to the fifth embodiment of the present invention described above, an additional antenna element may be provided on the antenna feed material so that the radio apparatus may have multiple functions.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A radio apparatus, comprising:
a printed board having an antenna feed circuit;
a casing material containing the printed board, the casing material provided with an antenna element formed by a conductive pattern formed on a face of the casing material facing the printed board; and
an antenna feed material arranged between the face of the casing material and the printed board; and
an electric connection between the antenna feed circuit and the antenna element through the antenna feed material.

2. The radio apparatus of claim 1, wherein
the antenna feed material is made of nonconductive material and provided with a feed conductor, and
the electric connection is formed by a first connection and a second connection, the first connection connecting the antenna feed circuit of the printed board and the feed conductor of the antenna feed material, the second connection connecting the feed conductor and the antenna element of the casing material.

3. The radio apparatus of claim 2, wherein the casing material is plated with the conductive pattern of the antenna element.

4. The radio apparatus of claim 2, wherein the antenna feed material is provided with an additional antenna element connected to a feed system different from the antenna feed circuit.

5. The radio apparatus of claim 2, wherein
the feed material is arranged in such a way that a portion of the feed material where the antenna feed circuit and the feed conductor are connected by the first connection is separate from the printed board, and
each of the first connection and the second connection is formed by a feed pin.

6. The radio apparatus of claim 2, wherein
the antenna feed material is put on a face of the printed board,
the first connection is formed by a pair of connectors to each other,
one of the connectors provided on the antenna feed material and another one of the connectors provided on the printed board, and
the second connection is formed by a feed pin.

7. The radio apparatus of claim 2, wherein
each of the feed conductor, the first connection and the second connection is formed by a signal side and a ground side paired with each other,
a portion of the antenna element is connected to a signal side of the antenna feed circuit through the signal sides of the second connection, the feed conductor and the first connection, and
another portion of the antenna element is connected to a ground side of the antenna feed circuit through the ground sides of the second connection, the feed conductor and the first connection.

8. The radio apparatus of claim 2, wherein
each of the antenna element, the feed conductor, the first connection and the second connection is formed by a signal side and a ground side paired with each other,
the signal side of the antenna element is connected to a signal side of the antenna feed circuit through the signal sides of the second connection, the feed conductor and the first connection, and
the ground side of the antenna element is connected to a ground side of the antenna feed circuit through the ground sides of the second connection, the feed conductor and the first connection.

9. The radio apparatus of claim 1, wherein
the antenna feed circuit includes a feed line,
the antenna feed material is made of nonconductive and heat-resistant material, and
the electric connection between the antenna feed circuit and the antenna element of the casing material is put on the antenna feed material and soldered to the feed line.

10. The radio apparatus of claim 9, wherein the casing material is plated with the conductive pattern of the antenna element.

11. The radio apparatus of claim 9, wherein the antenna feed material is provided with an additional antenna element connected to a feed system different from the antenna feed circuit.

12. The radio apparatus of claim 9, wherein the electric connection is formed by a feed pin.

13. The radio apparatus of claim 9, wherein
the electric connection is formed by a signal side and a ground side paired with each other,
a portion of the antenna element is connected to a signal side of the antenna feed circuit through the signal side of the electric connection, and
another portion of the antenna element is connected to a ground side of the antenna feed circuit through the ground side of the electric connection.

14. The radio apparatus of claim 9, wherein
each of the antenna element and the electric connection is formed by a signal side and a ground side paired with each other,
the signal side of the antenna element is connected to a signal side of the antenna feed circuit through the signal side of the electric connection, and
the ground side of the antenna element is connected to a ground side of the antenna feed circuit through the ground side of the electric connection.

15. The radio apparatus of claim 13, wherein
the signal side of the electric connection is a feed pin, and
the ground side of the electric connection is one of a conductive tape and a conductive gasket.

16. The radio apparatus of claim 14, wherein
the signal side of the electric connection is a feed pin, and
the ground side of the electric connection is one of a conductive tape and a conductive gasket.

17. An antenna device configured to be fed by an antenna feed circuit provided for a printed board of a radio apparatus, comprising:
an antenna element including a portion formed by a conductive pattern formed on a face of a casing material of the radio apparatus, the face of the casing material facing the printed board;
an antenna feed material arranged between the face of the casing material and the printed board; and
an electric connection between the antenna feed circuit and the antenna element through the antenna feed material.

18. The antenna device of claim 17, wherein
the antenna feed material is made of nonconductive material and provided with a feed conductor, and
the electric connection is formed by a first connection and a second connection, the first connection connecting the antenna feed circuit of the printed board and the feed conductor of the antenna feed material,
the second connection connecting the feed conductor and the antenna element of the casing material.

19. The antenna device of claim 17, wherein
the antenna feed circuit includes a feed line,
the antenna feed material is made of nonconductive and heat-resistant material, and
the electric connection between the antenna feed circuit and the antenna element of the casing material is put on the antenna feed material and soldered to the feed line.
